(19) United States
(12) Patent Application Publication
(10) Pub. No.: US 2009/0087159 A1
(43) Pub. Date: Apr. 2, 2009

(54) INFORMATION REPRODUCING DEVICE AND INFORMATION REPRODUCING METHOD

(75) Inventors: Atsushi Onoda, Tokyo (JP); Hitoshi Yoshida, Tokyo (JP)

Correspondence Address: KNOBBE MARTENS OLSON & BEAR LLP, 2040 MAIN STREET, FOURTEENTH FLOOR, IRVINE, CA, 92614, US

(73) Assignee: KUBUSHIKI KAISHA TOSHIBA, Tokyo (JP)

(21) Appl. No.: 12/202,033

(22) Filed: Aug. 29, 2008

(30) Foreign Application Priority Data
Sep. 28, 2007 (JP) JP-2007-256242

(51) Int. Cl. H04N 7/00

(52) U.S. Cl. 386/46

(57) ABSTRACT

According to one embodiment, an information reproducing device comprises a file creation module creating an application file, a decision module deciding whether a reading of the application is completed at a specified playback end time of the video object, a comparator module comparing in size between non-played back portion of the video object and the stored application file, a playback continuing module playing back the non-played back portion when it is smaller in size, and a readout module reading the stored application file when it is smaller in size.

### CROSS-REFERENCE TO RELATED APPLICATIONS

This application is based upon and claims the benefit of priority from Japanese Patent Application No. 2007-256242, filed Sep. 28, 2007, the entire contents of which are incorporated herein by reference.

### BACKGROUND

1. Field

One embodiment of the present invention relates to an information reproducing device and an information reproducing method which reproduce video data as a stream and make it possible to reproduce an application associated with the video data during playback of the video data.

2. Description of the Related Art

In recent years, on the basis of information recorded on a storage medium, such as an optical disk, it has become possible to readily provide not only playback of video data as a stream but also execute of an application (sub picture, still images, character information, etc.) associated with the video data during playback of the video data. There are various techniques for data structures to implement such reproduction processing.

For example, Japanese Patent Publication No. 2000-137632 discloses an optical disk including a moving image data recording area in which moving image data is recorded and a program recording area in which a program (application) associated with the moving image data is recorded.

However, according to the above publication, when a player continuously reads plural items of video data in a stream format from an optical disk, it is required to read a program to be reproduced from the program recording area during playback of each item of video data. Therefore, a playback head will move greatly with each playback of the program, resulting in an increase in seek time. As a result, there will arise a phenomenon in which the playback of video is interrupted frequently.

To solve this problem, in Japanese Patent Publication No. 2007-36945 corresponding to US 2007/0025698 A1, stream data being formed of a plurality of stream data units is recorded in the storage medium. Each stream data unit includes video data and an application to be played back during playback of the video data. The application and the video data are arranged to ensure that the application is read out prior to the video data.

The stream data read from such a storage medium is separated into the application and the video data in a demultiplexer. The video data is temporarily stored in an AV buffer. The AV buffer operates to initiate taking in the second video data before all the first video data are output from it. The application is temporarily stored in an application buffer. The application buffer is adapted to initiate and terminate taking in the application for the second video data within the time which elapses after termination of taking the first video data into the AV buffer before all of the first video data is output from the buffer. Thereby, the application and the video data are alternately taken in and stored. The application for the second video data is taken in within the time which elapses from the termination of taking in the first video data until all the data is output, allowing the application to be played back properly.

Advanced content which conforms to the HD DVD standards allow object mapping through a play list described by a content provider. Thereby, the order of playback can be defined by providing the playback start and end times of four types of presentation objects (primary video set, secondary video set, application, and advanced subtitle) and arranging each object on a time axis called the title time line. For this reason, depending on content, there may arise a case where video data used in the first play title is not displayed to the end and the display of the first play title is stopped prematurely.

For example, there is content in which the playback time of EVOB in which video data and application are multiplexed together is one minute and thirty seconds but the display time of the first play title is mapped into the play list as one minute. In such a case, displaying the main title immediately after the termination of the first play title display may result in failure to obtain a portion of an application associated with the first video data. Although special playback is impossible with the first play title, a similar thing will occur even when special playback, such as fast forwarding (FF) playback, is carried out while another tile having an application multiplexed is being displayed.

To cope with the above situation, it is suggested to store an application multiplexed with video data in a separate directory in the same file name, discard application data obtained halfway, and obtain the application in the separate directory. However, to read the separate directory, the playback head has to move greatly. This results in an increase in the seek time and consequently in the time required to start playback of the main title.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is an exemplary block diagram of an information reproducing device according to an embodiment of the present invention;

FIG. 2 shows an exemplary directory structure of an HD DVD;

FIG. 3 illustrates an exemplary multiplexing in an archiving file for advanced content of an HD DVD;

FIG. 4 illustrates an exemplary backup in a separate directory in the archiving file;

FIG. 5 shows an exemplary flowchart illustrating the information playback method of the present invention;

FIG. 6 shows an exemplary flowchart illustrating the information playback method of the present invention;

FIG. 7 is an exemplary diagram for use in explanation of a situation where a portion of the ACA file cannot be obtained; and

FIG. 8 is an exemplary diagram for use in explanation of the criterion for deciding whether to continue the playback of EVOB or to play back the ACA file in the separate directory under the situation of FIG. 7.

### DETAILED DESCRIPTION

Various embodiments according to the invention will be described hereinafter with reference to the accompanying drawings. In general, according to one embodiment of the invention, an information reproducing device adapted to reproduce information from an information storage medium which stores a video object in which video data and an application are multiplexed together and a play list to control a playback of the video object and stores an application file in another directory different from a directory in which the video object is stored, comprises:

a video object playback module configured to plays back the video object;

a file creation module configured to read the application from the video object during a playback of the video object and create an application file;

a decision module configured to make a decision of whether a reading of the application is completed at a specified playback end time of the video object;

a comparator module configured to, when a reading of the application is not completed, make a comparison in size between that portion of the video object which has not been played back and the application file stored in the other directory;

a playback continuing module configured to, when that portion of the video object which has not been played back is smaller in size, plays back that portion of the video object; and

a readout module configured to, when the application file stored in the other directory is smaller in size, read the application file stored in the other directory.

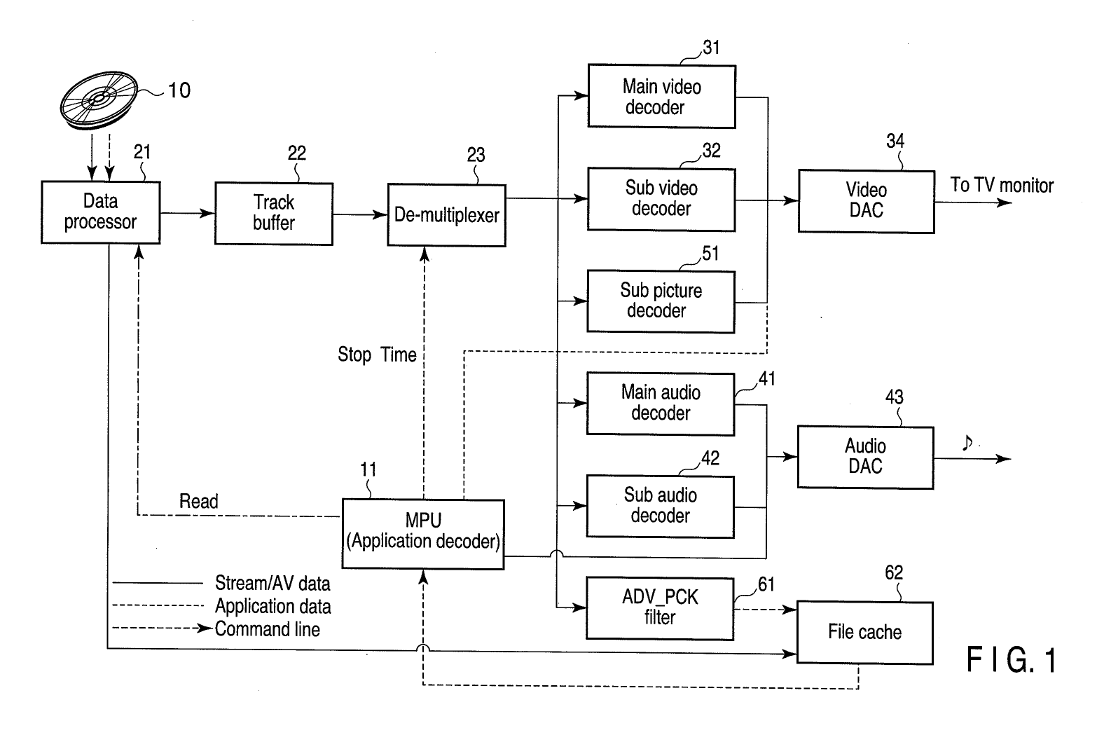

According to an embodiment, FIG. 1 shows a block diagram of an information reproducing device embodying the present invention.

An optical disk 10 is irradiated with laser light from an optical pickup head (not shown). Reflected light from the optical disk 10 is directed into the optical pickup head. A reproduced signal output from the optical pickup head is fed into a data processor 21. Each pack in a stream read from the data processor 21 is stored into a track buffer 22 and then transferred through a demultiplexer 23 to the input buffer (not shown) of a corresponding decoder. The track buffer 22 is adapted to secure the continuous supply of data to the decoder.

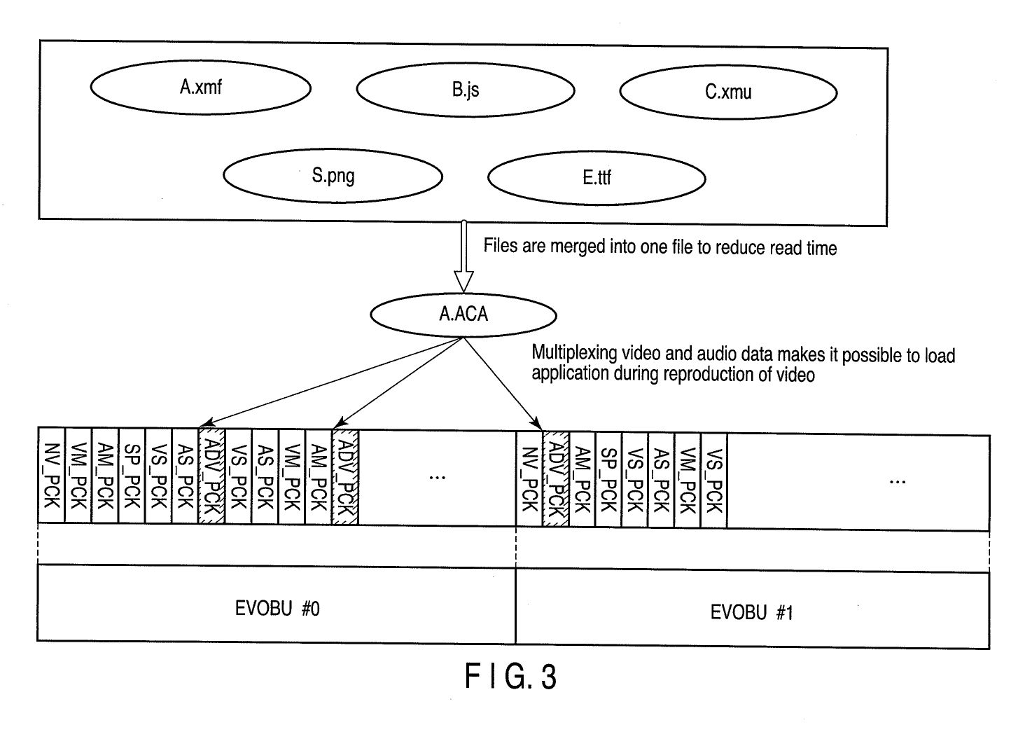

An example of a stream output from the data processor 21 is illustrated in FIG. 3. Here, a data stream of HD DVD advanced content is illustrated by example. A primary enhanced video object EVOB of advanced content is a data stream that contains presentation data of primary video sets. The primary enhanced video object EVOB conforms to a program stream of MPEG-2. Types of presentation data of the primary video set are main video, main audio, sub video, sub audio, and sub picture. NV_PCK is a navigation pack, VM_PCK a main video pack, AM_PCK a main audio pack. VS_PCK is a sub video pack, AS_PCK a sub audio pack, SP_PCK is a sub picture pack, and ADC_PCK is an advanced pack (archiving data). Thus, various packs forming main/sub video streams, main/sub audio streams, and advanced streams are multiplexed into an enhanced video object unit EVOBU.

Application is a presentation object which is capable of playback control of primary and secondary video sets, playback control of images and effective sound data, display of text data using font data, control of user inputs, and application control.

The application comprises a manifest which provides an initial setting for starting the application; a markup which controls the display or operation of the application; a script which controls the display or operation of the application and primary and secondary video sets; image data; effective sound data; font data; and an archiving file. The image, effective sound, font and archiving file are generically referred to as advanced elements.

The archiving file is a format for archiving, as one file, files forming the application or used in the application (i.e., play list [XPL], manifest [XMF], markup [XMU, XAS], script [JS], images [JPG, PNG], effective sound [WAV], fonts [OTF, TTF, TTC], secondary video set [EVO], ECMA script [JS], and the like). It takes long to read individual files (A.XMF, B.JS, C.XMU, D.PNG, E.TTF, etc.); however, reading them as one archiving file allows the read time to be reduced.

The archiving file is multiplexed in EVOB of the primary video set as an advanced stream. The file is divided into packs called advanced packs (ADV_PCK). This allows the archiving file to be automatically loaded into a file cache during playback of the primary video set.

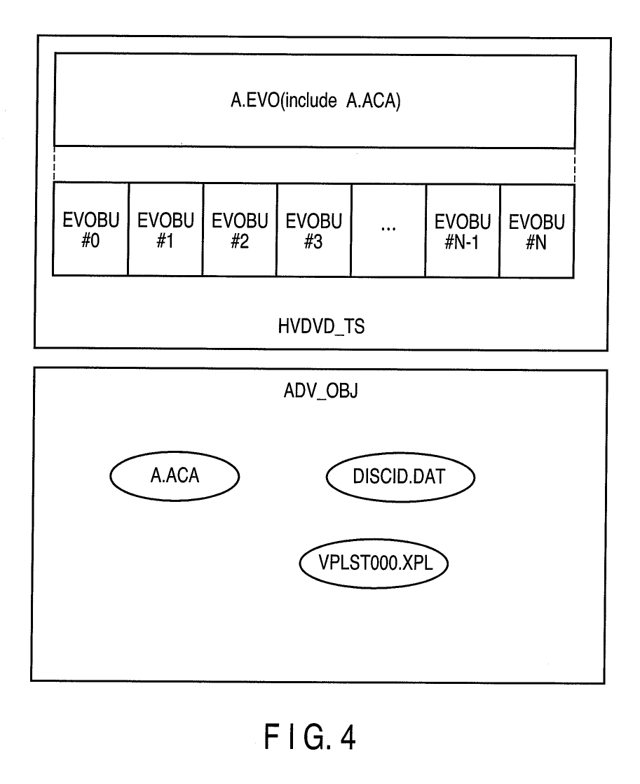

With special playback, such as FF, there is the possibility that the enhanced video object EVOB may not be loaded to the end. That is, all the advanced packs in one advanced stream are not necessarily obtained. The archiving file (ACA file) prior to multiplexing (ADV_PCK version of the file) is always stored (backed up) under the same file name (A.ACA) in a separate directory (ADV_OBJ) as shown in FIG. 4. The enhanced video object EVOB file containing the archiving file (A.ACA) is denoted by A.EVO. The enhanced video object EVOB file (A.EVO) is stored in an HVDVD_TS directory. The archiving file (A.ACA) is stored in an ADV_OBJ directory or supplied from a network or persistent storage.

Returning now to FIG. 1, the main video pack VM_PCK is applied to a main video decoder 31, the main audio pack AM_PCK to a main audio decoder 41, the sub video pack VS_PCK to a sub video decoder 32, the sub audio pack AS_PCK to a sub audio decoder 42, the sub picture pack SP_PCK to a sub picture decoder 51, and the advanced pack ADV_PCK to the input buffer of an advanced pack filter 61.

The output signals of the main video decoder 31, the sub video decoder 32 and the sub picture decoder 51 are applied via a video DAC 34 to a TV monitor not shown as analog video signals. The output signals of the main audio decoder 41 and the sub audio decoder 42 are applied via an audio DAC 44 to a loudspeaker not shown as analog audio signals. The output signal of the advanced pack filter 61 is applied to an application decoder 11 comprised of an MPU. The output signal of the application decoder 11 is applied to the TV monitor via the video DAC 34 as an analog video signal or to the loudspeaker via the audio DAC 43 as an analog audio signal.

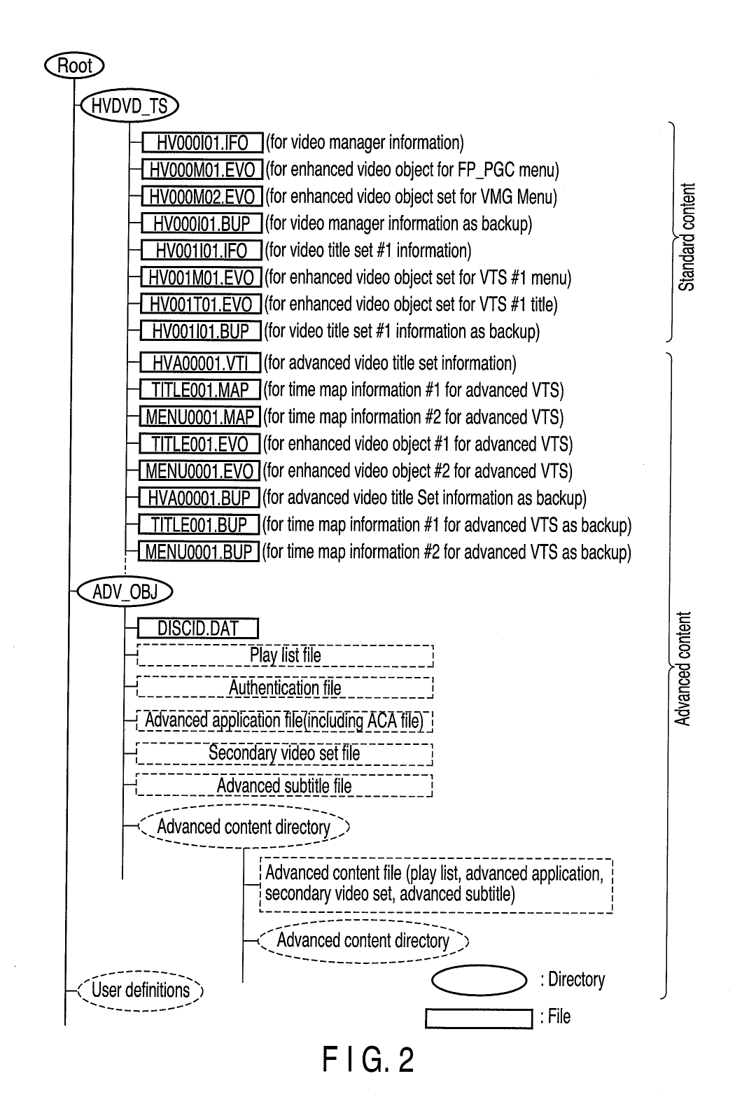

FIG. 2 shows the organization of directories on an HD DVD disk. The HDDVD_TS directory is placed immediately below the root directory to contain all the files (for example, VMG, standard video set, advanced VTS, etc.) associated with the primary video set. With a disk of category 2 which contains only an advanced content of play list, primary video set (advanced VTS alone), secondary video set, and advanced subtitle or a disk of category 3 which contains a standard content and an advanced content, the ADV_OBJ directory is placed immediately below the root directory. The ADV_OBJ directory contains all the play list files and one of the advanced navigation, advanced element, and secondary video set files. Note that the disk of category 1 is one which contains only standard content of one VMG and standard VTS.

If it is required to read the play list file in the startup sequence for advanced content, the play list file should be present in the ADV_OBJ directory. The play list file name is VPLST%%%.XPL for a player connected to the display device, or APLST&&&.XPL for a player which is not connected to the display device. “%%%” and “&&&” are both arbitrary values in the range of 000 to 999. In the startup sequence, the play list having the maximum number is read first.

The play list is data in XML form for performing playback control of four presentation objects of primary video set, secondary video set, application, and advanced subtitle and system initialization. That is, the play list is basic information to play back advanced content.

Data on a disk is formed from a number of titles, which have a time axis called the title time line. The play list provides the start and end times of playback of the aforementioned four presentation objects and arranges each of the objects on the title time line, thereby allowing the order of playback of the four presentation objects to be defined.

The advanced content directory is placed below the ADV_OBJ directory and contains files of the play list, application, secondary video set, and advanced subtitle.

The play list file describes navigation, synchronization, and initial system configuration for advanced content. The play list contains title information, media attribute information, and configuration information. The title information includes a first play title, presentation clip element, and object mapping unit.

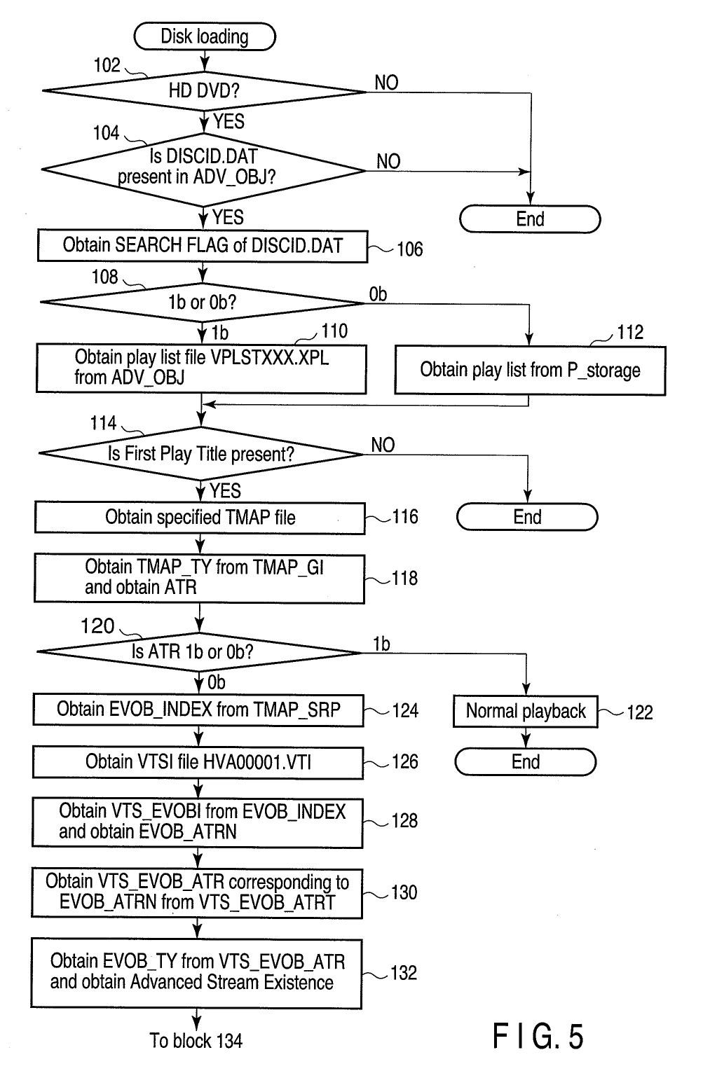

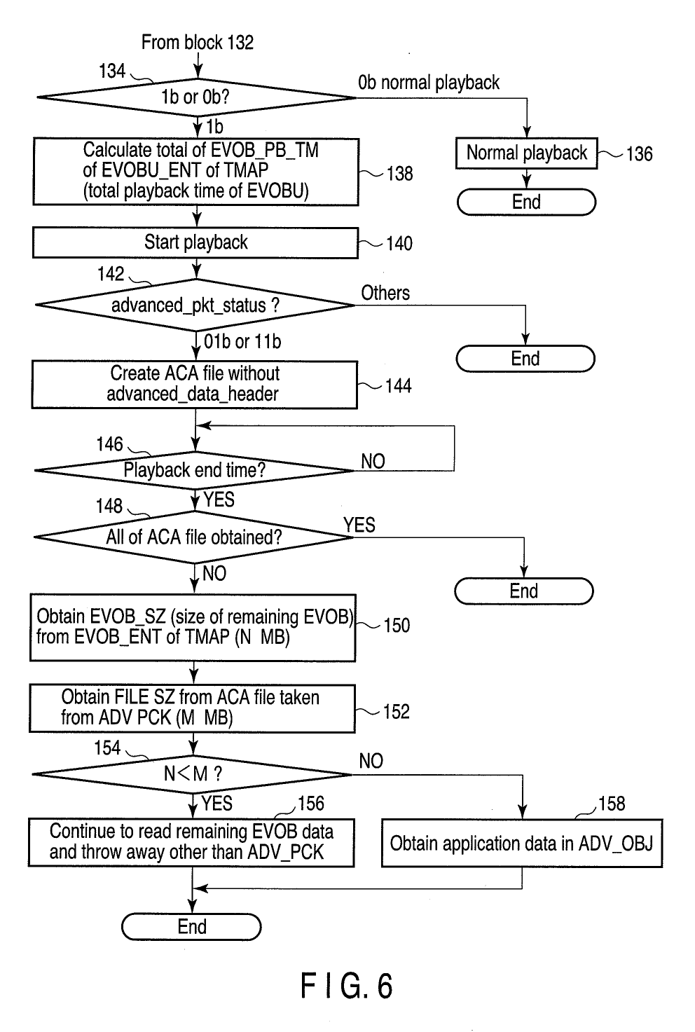

Reference is next made to FIGS. 5 and 6 to describe the operation of the information reproducing device embodying the invention.

When an optical disk 10 is loaded into the player, a decision is made as to whether or not the disk is an HD DVD disk (block 102). If the decision is NO, the procedure comes to an end.

If the decision is YES, then a decision is made as to whether or not it contains an advanced content (block 104). If the decision is NO, the procedure comes to an end.

An HD DVD disk containing an advanced content has such an organization of directories as shown in FIG. 2. Thus, it is possible to decide whether or not the disk contains an advanced content depending on whether or not the DISCID.DAT file is present in the ADV_OBJ directory.

If the disk is an HD DVD disk that contains an advanced content, SEARCH_FLAG in the DISCID.DAT file is obtained (block 106). A decision is next made as to whether the value is 1 b or 0 b (block 108).

When the SEARCH_FLAG value is 1 b, a search is made through play list files VPLSTxxx.XPL (xxx is a 3-digit number) in the ADV_OBJ directory for the one which is the greatest in number (block 110).

If the SEARCH_FLAG value is 0 b, on the other hand, a search is also made through play list files in the persistent storage P-Storage for the one which is the greatest in number (block 112).

An analysis is made of the First Play List file thus obtained to make a decision of whether or not the First Play Title is present (block 114). If the decision is NO, the procedure comes to an end.

This example supposes the presence of such a file. Thus, a TMAP (TimeMAP) file specified by the First Play Title is obtained (block 116).

TMAP_TY (Attribute of TMAP) is obtained from TMAP_GI (TMAP General Information) and ATR is obtained from TMAP_TY (block 118). A decision is next made as to whether the ATR value is 1 b or 0 b (block 120).

If ATR is 1 b, then a normal playback is carried out because EVOB which specified the TMAP is one in the secondary video set and hence no ADV_PCK is present (block 122).

When the ATR value is 0 b, it is required to decide whether ADV_PCK is present or absent because EVOB specified the TMAP is a primary audio video.

First, EVOB_INDEX (EVOS [Enhanced Video Object] index number) is obtained from TMAP Search Pointer (TMAPI_SRP) (block 124).

Next, Video Title Set Information (VTSI) file HVA00001.VTI in an advanced content is obtained (block 126). VTS_EVOBI (VTS_EVOB information) indicated in the obtained EVOB_INDEX is obtained and then EVOB_ATRN (EVOB Attribute number) is obtained from VTS_EVOBI (block 128).

VTS_EVOB_ATR corresponding to EVOB_ATRN is obtained from VTS_EVOS_ATRT (VTS_EVOB Attribute Table) (block 130).

EVOB TY (EVOB type) is obtained from VTS_EVOB_ATR and Advanced stream existence is obtained (block 132). A decision is made as to whether the value is 01 b or 00 b (block 134).

When Advanced Stream Existence is 00 b, a normal playback is carried out (block 136). This is because Advanced Stream Existence, i.e., ADV_PCK, is not present in that EVOB.

When Advanced Stream Existence is 01 b, Advanced Stream Existence, i.e., ADV_PCK, is present in that EVOB. In this case, the total of EVOBU_PB_TM (EVOBU PlayBack Time) of TMAP EVOBU_ENT (EVOB unit Entry) is calculated (block 138). This provides the total playback time of EVOB (original EVOB playback time).

EVOBU corresponding to the playback start time described in the play list is calculated from TMAP to start playback (block 140).

If, when clipTimeBegin (offset from the top of EVOB) described in the play list is 0 (0 when not described), the specified playback time (titleTimeEnd−titleTimeBegin) is shorter than the calculated total playback time of EVOB, there is the possibility of the occurrence of problems. That is, there arises the situation in which a portion of ADV_PCK cannot be obtained. However, even if the specified playback time is shorter than the total playback time of EVOB, playback over the time specified in the play list by a content provider is impossible because it is against the standards. Therefore, video, audio and subtitle data in EVOB are played back only until the specified time.

In advanced_data_header of ADV_PCK, there is provided advanced_pkt_status which is capable of obtaining the ACA file status in ADV_PCK. If, when the playback of EVOB is started, advanced_pkt_status is 01 b or 11 b, portions other than advanced_data_header in ADV_PCK are transferred to the file cache 62 to create the ACA file because the top of the ACA file is contained (block 144).

When advanced_pkt_status is 11 b, no problem occurs because the ACA file can be obtained with only one pack.

When advanced_pkt_status is 01 b, the ACA file is extracted from ADV_PCK and transferred to the file cache 62 until ADV_PCK for which advanced_pkt_status is 10 b is obtained. This is continued to the playback end time (block 146).

If, when the specified playback end time arrives, a pack in which advanced_pkt_status is 10 b is entered, FILE_SZ (File Size) in the header of the ACA file (ACA file demultiplexed and retained in the file cache 62) is obtained. A comparison is made with the size of the ACA file transferred to the file cache 62. If the size comparison indicates equality, no problem occurs because all the information has been obtained (block 148). When all the information has been obtained, the procedure comes to an end.

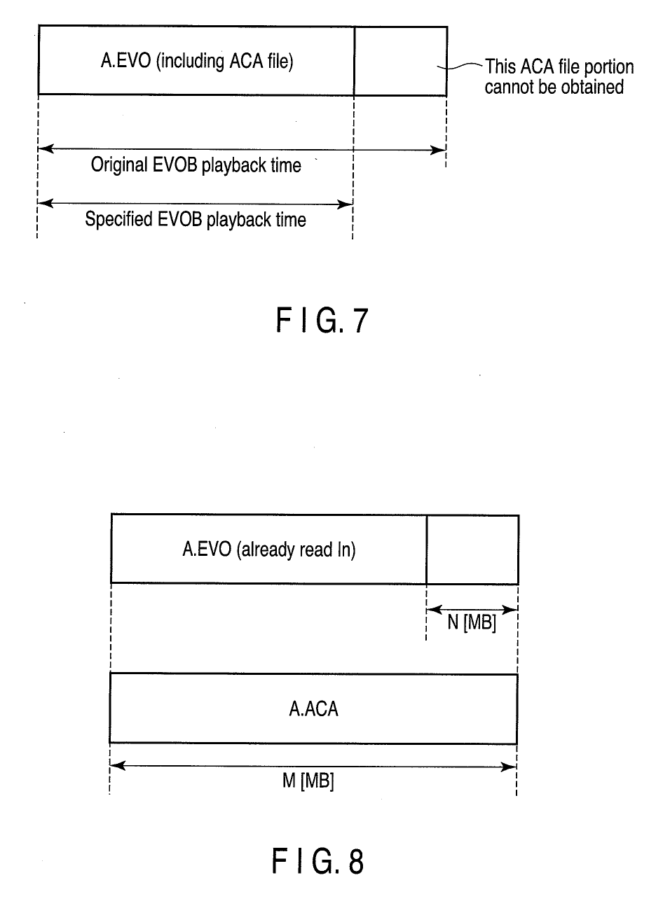

When no pack for which advanced_pkt_status is 10 b has been entered until the specified playback end time, a portion of the ACA file has not been obtained as shown in FIG. 7. The remaining EVOB size is obtained from EVOBU_SZ (EVOBU Size) of EVOBU_ENT of TMAP. The remaining EVOB size is assumed to be N [MB] (block 150).

FILE SZ of the ACA file is obtained from the ACA header taken out from ADV_PCK (block 152). This is assumed to be M [MB].

When N<M as shown in FIG. 8, the remaining EVOB data (N [MB]) continues to be read. However, since AV data, such as sound and subtitles, are not needed, data other than ADV_PCK are discarded after reading in the demultiplexer 23 (block 156). This makes it possible to read almost in the read time from the disk regardless of video time.

If, on the other hand, M<N, an application file (M [MB]) in ADV_OBJ is obtained in the conventional way (block 158). Before obtaining, the application file created so far and stored in the file cache 62 is discarded.

It is not known where in the EVOB the ADV_CPK is multiplexed. Therefore, if ADV_PCK in which advanced_pkt_status is 01 b or 11 b is not entered within the playback time, it is also expected that the ACA file has not been obtained at all. In such a case, ACA file in the ADV_OBJ directory is forcefully obtained.

As described above, when the playback of a stream EVOB in which video and an application are multiplexed together is prematurely terminated and a portion of the application cannot be obtained, a comparison is made between the remaining EVOB size and the size of an application file stored in a separate directory to read data of smaller size. When the remaining EVOB is read as it is, there is no need of seek by the head, thus allowing the remaining application to be read in a short time. When the size of the remaining EVOB is larger, from a time saving viewpoint it is better to read only a non-multiplexed application file from the beginning even if a seek time is required. The EVOB is some gigabytes and the archiving file is some megabytes in size. It is fruitless to discard data in the middle of being obtained and moreover it takes long time to start the playback of the next title. Therefore, the embodiment provides a method which reduces the seek time without searching again by, when EVOB has been halfway read, reading the remaining data in the EVOB, discarding the video data, and obtaining only application data. However, there is no significance when the remaining EVOB data is larger in size than the entire archiving file to be actually acquired. A comparison is therefore made in size between the remaining EVOB data and the archiving file. By reading that which is smaller in size, it becomes possible to start the playback of the next title earlier than conventional. When continuing to read, power consumption can also be reduced because useless processing of discarding data can be omitted.

According to the present invention, as described above, even if the playback of a stream in which video and an application are multiplexed together is prematurely terminated and a portion of the application cannot be obtained, a comparison is made in size between the remaining stream and an application file stored in a separate directory to read data of smaller size. When the remaining stream is smaller in size, there is no need of head seek, thus allowing the remaining application to be read in a short time. When the remaining stream is larger, reading the application file stored in the separate directory from the beginning requires less time than reading the application obtained from its middle.

The present invention is not limited to the embodiment described above. At the stage of practice, the invention can be embodied in modified forms without departing from the scope thereof. The constituent elements disclosed in the embodiment can be combined appropriately to form various inventions. For example, some constituent elements may be removed from all the constituent elements disclosed herein.

Furthermore, the present invention can be implemented in the form of a computer readable storage medium stored with a program which allows a computer to execute predetermined means, to function as predetermined means, or to perform predetermined functions.

For example, the embodiment has been described taking the first play list by way of example; however, in the event that the playback of EVOB is stopped prematurely even with another title, deciding the acquisition of the remaining ADV_PCK using the same algorithm allows the time which elapses until the playback of the next title is initiated to be reduced. With the first play list, it is impossible for the user to perform an action, such as title skip. With other titles, although the playback of EVOB to the end has been specified on the play list, user operations may cause the playback to terminate prematurely. Even in such a case, making a comparison in size between EVOB and application data and selecting that which is smaller is size would allow switching to the next title in a minimum time.

FIG. 1 illustrates a hardware implementation of an HD DVD player. The track buffer 22, the demultiplexer 23, the decoders 31, 32, 51, 41 and 42, and the ADV_PCK filter 61 shown in FIG. 1 may be implemented in software.

In addition, use may be made of AV data in a format in which video and sound from one data source and other application data are contained.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. An information reproducing device configured to reproduce information from an information storage medium configured to store a video object in which video data and an application are multiplexed together and a play list to control a playback of the video object in a first directory and to store an application file in a second directory, comprising:
a video object playback module configured to play back the video object;
a file creation module configured to retrieve the application from the video object during a playback of the video object and to create an application file;
a decision module configured to make a decision of whether retrieving the application is completed at an end time of the playback of the video object;
a comparator configured to make a comparison in size between a portion of the video object which has not been played back and a portion of the application file stored in the second directory when the retrieving of the application is not completed;
a playback continuing module configured to play back the portion of the video object when the portion of the video object is smaller in size than the portion of the application file; and
a readout module configured to read out the application file stored in the second directory when the application file stored in the second directory is smaller in size than the portion of the video object.

2. The information reproducing device of claim 1, wherein video streams, audio streams and advanced data streams are multiplexed in the video object, the advanced data streams comprising the application file, and the file creation module comprises a demultiplexer configured to separate a stream of the played back video object into the video streams, the audio streams and the advanced data streams and a file cache configured to store the advanced data streams separated by the demultiplexer.

3. The information reproducing device of claim 2, wherein the application is an archive file comprising at least one file of play lists, manifest, markup, scripts, images, effective sound, fonts, a secondary video set, and ECMAScript as one file, the archive file being formed to be divided into the advanced data streams.

4. The information reproducing device of claim 1, wherein the decision module is configured to make a comparison in size between the application file already created and the application file stored in the second directory.

5. The information reproducing device of claim 1, wherein the playback continuing module is configured to read and discard the video data during the playback of the portion of the video object which has not been played back.

6. The information reproducing device of claim 1, wherein the video object is stored in the first directory and the play list and the application file are stored in the second directory.

7. An information reproducing method of reproducing information from an information storage medium configured to store a video object in which video data and an application are multiplexed together and a play list to control a playback of the video object in a first directory and to store an application file in a second directory, comprising:
playing back the video object;
retrieving the application from the video object during a playback of the video object and creating an application file;
deciding whether the retrieving the application is completed at an end time of the playback of the video object;
comparing in size between a portion of the video object which has not been played back and a portion of the application file stored in the second directory when retrieving the application is not completed;
continuing playback of the portion of the video object when the portion of the video object which has not been played back is smaller in size than the portion of the application file; and
retrieving the application file stored in the second directory, when the portion of the application file stored in the second directory is smaller in size than the portion of the video object.

8. The information reproducing method of claim 7, wherein the deciding step comprises the step of comparing in size between the application file already created and the application file stored in the second directory.

9. The information reproducing method of claim 7, wherein the step of continuing comprises reading and discarding video data during the playback of the portion of the video object which has not been played back and continuing to create the application file.
